(19) United States
(12) Patent Application Publication
(10) Pub. No.: US 2025/0208406 A1
(43) Pub. Date: Jun. 26, 2025

(54) OPTICAL SCANNING APPARATUS AND IMAGE FORMATION APPARATUS

(71) Applicant: CANON KABUSHIKI KAISHA, Tokyo (JP)

(72) Inventor: SOYA SAIJO, Tochigi (JP)

(21) Appl. No.: 18/984,653

(22) Filed: Dec. 17, 2024

(30) Foreign Application Priority Data
Dec. 21, 2023 (JP) 2023-215786
Oct. 23, 2024 (JP) 2024-186517

(51) Int. Cl. G02B 26/10; B41J 2/47; G02B 26/08; G03G 15/00; G03G 15/04; G03G 15/043

(52) U.S. Cl. CPC G02B 26/10; B41J 2/471; G02B 26/0816; G03G 15/04036; G03G 15/0435; G03G 15/5087

(57) ABSTRACT

An optical scanning apparatus includes a deflector including a deflection surface, on which first and second light beams are deflected to scan first and second scanned surfaces in a main scanning direction, and first and second optical systems configured to guide the first and second light beams deflected by the deflection surface to the first and second scanned surfaces wherein the first optical system includes first refractive element, a second refractive element, and first reflective element, wherein the second optical system includes a third refractive element, a second reflective element, a fourth refractive element, and a third reflective element, wherein at least one of the first refractive element and the third refractive element includes a specific optical surface, and wherein distances on the optical axis from an axial deflection point on the deflection surface to the second and fourth refractive elements differ from each other.

### BACKGROUND

### Technical Field

The present exemplary embodiment relates to an optical scanning apparatus, in particular, suitable for an image formation apparatus, such as a laser beam printer (LBP), a digital copying machine, or a multifunction printer (MFP).

### Description of the Related Art

In recent years, there has been known optical scanning apparatuses that are configured to deflect a plurality of light beams emitted from a plurality of light sources with a (the same) deflector and scan a plurality of surfaces to be scanned via a plurality of imaging optical systems in order to achieve small size.

To carry out additional downsizing while avoiding interference between optical elements provided in the imaging optical systems, Japanese Patent Application Laid-Open No. 2012-013754 discloses an optical scanning apparatus of which the lengths of optical paths in the imaging optical systems differ from each other.

### SUMMARY

According to some embodiments, an optical scanning apparatus includes a deflector including a deflection surface, on which a first light beam and a second light beam are deflected to scan a first scanned surface and a second scanned surface, respectively, in a main scanning direction, and a first optical system and a second optical system configured to guide the first light beam and the second light beam deflected by the deflection surface to the first scanned surface and the second scanned surface, respectively, wherein the first optical system includes a first refractive element, a second refractive element, and a first reflective element arranged in an order from the deflection surface to the first scanned surface, wherein the second optical system includes a third refractive element, a second reflective element, a fourth refractive element, and a third reflective element arranged in an order from the deflection surface to the second scanned surface, wherein at least one of the first refractive element and the third refractive element includes an optical surface in which a normal line on a generatrix is non-parallel to an optical axis in a sub-scanning cross section, and wherein distances on the optical axis from an axial deflection point on the deflection surface to the second refractive element and the fourth refractive element differ from each other.

Further features of the present disclosure will become apparent from the following description of exemplary embodiments with reference to the attached drawings.

### BRIEF DESCRIPTION OF THE DRAWINGS

FIG. 1A is a sub-scanning cross-sectional view of an optical scanning apparatus according to a first exemplary embodiment.

FIG. 1B illustrates light paths in a main-scanning cross-sectional view of the optical scanning apparatus corresponding to a light source 1A according to the first exemplary embodiment.

FIG. 1C illustrates light paths in a main-scanning cross-sectional view of the optical scanning apparatus corresponding to a light source 1B according to the first exemplary embodiment.

FIG. 1D illustrates a light path development in a sub-scanning cross-sectional view of the optical scanning apparatus according to the first exemplary embodiment.

FIG. 2A is a sub-scanning cross-sectional view of the optical scanning apparatus according to the first exemplary embodiment.

FIG. 2B is a sub-scanning cross-sectional view of an optical scanning apparatus according to a comparative example.

FIG. 3A is a sub-scanning cross-sectional view of an optical scanning apparatus according to a second exemplary embodiment.

FIG. 3B illustrates light paths in a main-scanning cross-sectional view of the optical scanning apparatus corresponding to a light source 1A according to the second exemplary embodiment.

FIG. 3C illustrates light paths in a main-scanning cross-sectional view of the optical scanning apparatus corresponding to a light source 1B according to the second exemplary embodiment.

FIG. 3D illustrates light paths in a sub-scanning cross-sectional view of the optical scanning apparatus according to the second exemplary embodiment.

FIG. 4 is a sub-scanning cross-sectional view of a color image formation apparatus.

### DESCRIPTION OF THE EMBODIMENTS

In the following description, a main scanning direction (a Y-direction) is a direction perpendicular to the rotation axis (or the oscillation axis) of a deflector and the optical axis of an optical system (a direction in which a light beam is reflected and deflected, i.e., deflected and scanned by a rotatable polygon mirror). A sub scanning direction (a Z-direction) is a direction parallel to the rotation axis (or the oscillation axis) of the deflector.

A main-scanning cross section is a cross section including the optical axis and perpendicular to the sub scanning direction. A sub-scanning cross section is a cross section perpendicular to the main scanning direction.

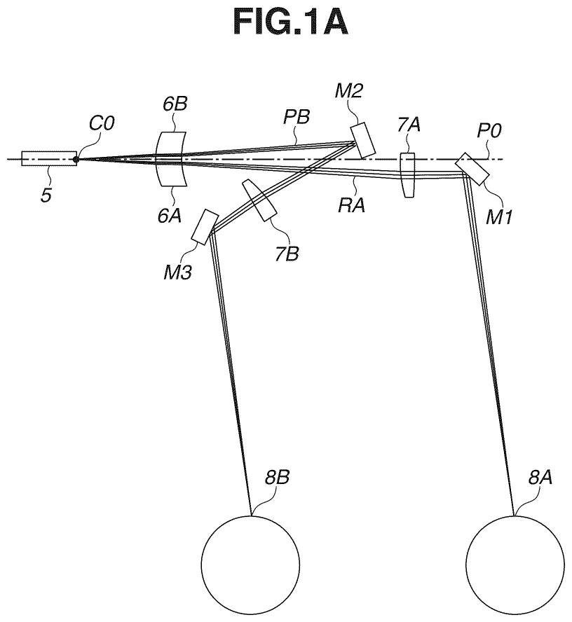

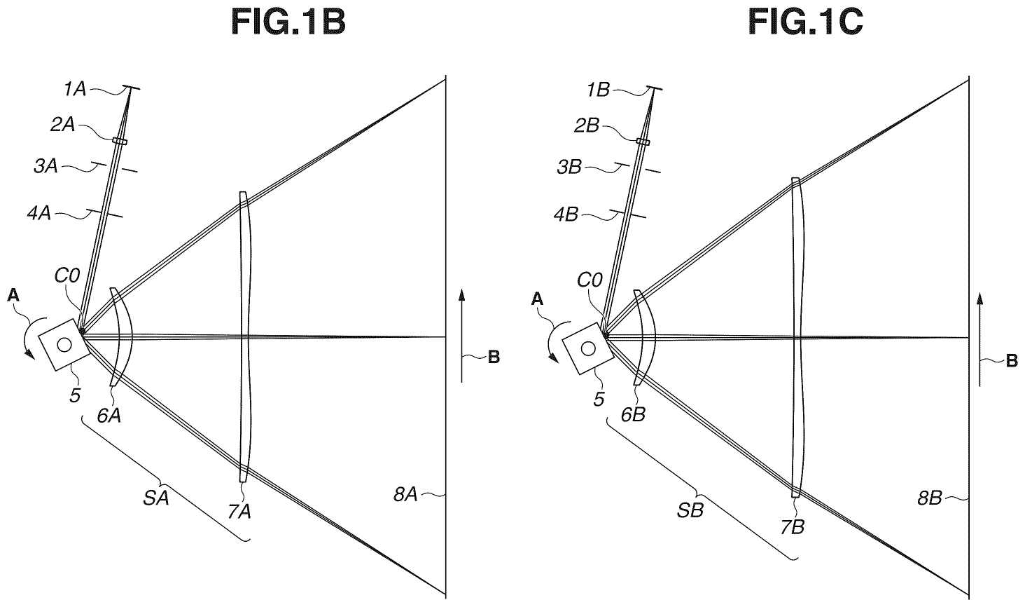

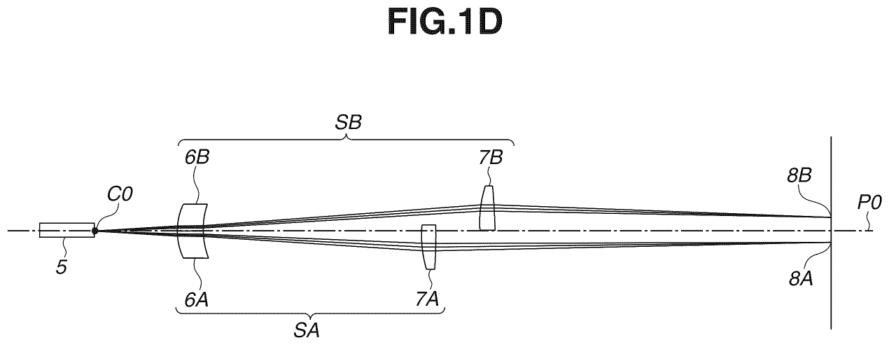

A first exemplary embodiment will now be described. FIG. 1A is a sub-scanning cross-sectional view of main components of an optical scanning apparatus 100 according to the first exemplary embodiment. FIGS. 1B and 1C are a light path view in a main-scanning cross section of the main components of the optical scanning apparatus 100 according to the first exemplary embodiment. FIG. 1C is a light path view in a sub-scanning cross section of the main components of the optical scanning apparatus 100 according to the first exemplary embodiment.

The optical scanning apparatus 100 according to the present exemplary embodiment includes a light source 1A (a first light source), a light source 1B (a second light source), incident optical systems LA and LB, a deflector 5, an imaging optical system SA (a first optical system), an imaging optical system SB (a second optical system), and mirrors (reflective elements) M1, M2, and M3.

In the optical scanning apparatus 100 according to the present exemplary embodiment, the single deflector 5 deflects both a light beam RA (a first light beam) and a light beam RB (a second light beam) that scan a scanned surface 8A (a first scanned surface) and a scanned surface 8B (a second scanned surface), respectively. The optical scanning apparatus 100 according to the present exemplary embodiment uses a so-called sub-scanning oblique incident optical system. In the oblique incident optical system, the light beams share the single deflector 5, and the light beams are incident on the deflector 5 obliquely in the sub-scanning direction. The sub-scanning oblique incident optical system has an advantage that deflected and reflected light beams can be separated without enlargement of the deflection and reflection surface of the optical deflector in the sub scanning direction.

Semiconductor lasers are used as the light sources 1A and 1B. The number of light emitting points of the light sources 1A and 1B can be one or more.

The incident optical systems LA and LB include anamorphic lenses 2A and 2B as refractive elements, sub-scanning aperture diaphragms 3A and 3B, and main-scanning aperture diaphragms 4A and 4B, respectively.

The anamorphic lenses 2A and 2B convert the light beams RA and RB emitted from the light sources 1A and 1B into parallel light beams in the main-scanning cross section to condense the parallel light beams in the sub-scanning direction. Here, the parallel light beams include parallel light beams strictly, and substantially parallel light beams, such as slightly divergent light beams and slightly convergent light beams. In addition, a collimator lens and a cylinder lens can be used instead of an anamorphic lens.

The scanning aperture diaphragms 3A and 3B limit the diameters of the light beams RA and RB in the sub scanning direction passed through the anamorphic lenses 2A and 2B, respectively. Similarly, the main-scanning aperture diaphragms 4A and 4B limit the diameters of the light beams RA and RB in the main scanning direction passed through pass through the anamorphic lenses 2A and 2B, respectively.

The deflector 5 is rotated in arrow A directions in FIGS. 1B and 1C by a not-illustrated driving device, such as a motor, to deflect the incident light beams RA and RB to scan the scanned surfaces 8A and 8B in directions B in FIGS. 1B and 1C. The deflector 5 is a polygon mirror, for example.

In the imaging optical system SA, the deflected light beam RA, which is deflected and reflected by a deflection and reflection surface 5A of the deflector 5, passes through a lens 6A (a first refractive element) and a lens 7A (a second refractive element). Thereafter, the deflected light beam RA is folded by the mirror (a first reflective element) M1 and guided to the scanned surface 8A. In addition, in the imaging optical system SB, the deflected light beam RB, which is deflected and reflected by the deflection and reflection surface 5A of the deflector 5, passes through a lens 6B (a third refractive element). The deflected light beam RB is folded by the mirror (a second reflective element) M2. Then, after passing through a lens 7B (a fourth refractive element), the deflected light beam RB is folded by the mirror (third reflective element) M3 and guided to the scanned surface 8B.

The mirrors M1, M2, and M3 are units (the reflective elements), each of which reflects a light beam, and are each a vapor deposition mirror, for example. Instead of the mirrors M1, M2, and M3, optical elements, such as lenses or prisms including reflection surfaces, can be used as the reflection elements. Instead of the lenses, a prism can be used as the refractive element.

Here, an incident point (a deflection point) C0 illustrated in FIGS. 1A to 1C is each an incident point (a deflection point) on a deflection surface of the principal ray of a light beam (the axial light beam) that will reach an axial image height on the scanned surface, the deflection surface where the principal ray is deflected. Hereinafter, the incident point C0 will be referred to as an axial deflection point. A plane (a reference plane) P0 passes through the deflection point C0 and is perpendicular to the rotation axis of the deflector 5. The light beams RA and RB incident on the reflection surface 5A intersect each other and are deflected at the deflection point C0 in the sub-scanning cross section.

Hereinafter, the length of an optical path from the deflection point C0 to each of the scanned surfaces will be the length of the optical path of each of the imaging optical systems.

Tables 1 to 4 below show specifications, optical arrangements, and lens surface shapes of the optical scanning apparatus 100 according to the present exemplary embodiment. Table 1 shows specifications and lens arrangements of the incident optical system LA and the imaging optical system SA. Table 2 shows lens surface shapes of the incident optical system LA and the imaging optical system SA. Table 3 shows specifications and lens arrangements of the incident optical system LB and the imaging optical system SB. Table 4 shows lens surface shapes of the incident optical system LB and the imaging optical system SB. Some cells of the optical arrangements in Tables 1 and 3 show the coordinates of reflection points on the mirrors of the light beams RA and RB that travel toward the image center (the axial image height) of the scanned surface in the main scanning direction.

In Tables 2 and 4, an axis in the optical axis direction, an axis orthogonal to the optical axis in the main-scanning cross section, and an axis orthogonal to the optical axis in the sub-scanning cross section are an X-axis, a Y-axis, and a z-axis, respectively, the three axes of which the origin is the point of intersection of the optical axis with each lens surface. The light traveling direction on the X axis is the +x direction. The light source side of the optical axis on the Y axis corresponds to the +y direction. In Tables 2 and 4, “E-x” represents “×10^{-x}”.

TABLE 1
Specifications

| | | |
|---|---|---|
| Laser wavelength (nm) | Λ | 790 |
| Incident angle (deg) in main scanning | Am | 78 |
| direction from incident optical | | |
| system to deflector | | |
| Incident angle (deg) in sub scanning | As | 2.7 |
| direction from incident optical | | |
| system to deflector | | |
| Refractive index of anamorphic lens | n2 | 1.524 |
| Refractive index of imaging lens 6 | n6 | 1.524 |
| Refractive index of imaging lens 7 | n7 | 1.524 |
| Diameter of sub-scanning aperture | Z-direction | 2.84 |
| (rectangular shape) (mm) | | |
| Diameter of main-scanning aperture | Y-direction | 3.75 |
| (rectangular shape) (mm) | | |
| Coordinate of rotation axis of | X-direction | −6.03 |
| polygon mirror (mm) | Y-direction | −3.79 |
| (Define coordinates of axial | | |
| deflection point of imaging optical | | |
| system SA as (0, 0, 0)) | | |
| fθ coefficient (mm/rad) | K | 207 |
| Diameter of circumscribed circle | Rp | 20 |
| on coordinate of rotation axis of | | |
| polygon mirror (mm) | | |
| Number of surfaces of polygon mirror | MEN | 4 |
| Maximum scanning angle of view (deg) | Θmax | ±45.12 |
| Image height on scanned surface (mm) | W | ±163 |

Optical arrangements

| | | Incident optical system LA, imaging optical system SA | | | | | |
|---|---|---|---|---|---|---|---|
| | | | | | Direction of optical axis | | |
| | | Coordinates of surfaces | | | (indicated by direction cosine) | | |
| | | X- | Y- | Z- | X | Y | Z |
| | | coordinate | coordinate | coordinate | component | component | component |
| Light source | | 33.582 | 157.991 | 7.617 | 0.208 | 0.977 | 0.047 |
| Anamorphic | Incident | 26.606 | 125.171 | 6.035 | 0.208 | 0.977 | 0.047 |
| lens | surface | | | | | | |
| | Light | 25.983 | 122.240 | 5.893 | 0.208 | 0.977 | 0.047 |
| | emitting | | | | | | |
| | surface | | | | | | |
| Sub-scanning aperture | | 22.837 | 107.438 | 5.180 | 0.208 | 0.978 | 0.000 |
| Main-scanning aperture | | 16.633 | 78.253 | 3.773 | 0.208 | 0.978 | 0.000 |
| Polygon | Deflection | 0.000 | 0.000 | 0.000 | — | — | — |
| mirror | surface | | | | | | |
| Imaging | Incident | 26.000 | 0.000 | 0.000 | 1.000 | 0.000 | 0.000 |
| lens 6 | surface | | | | | | |
| | Light | 34.200 | 0.000 | 0.000 | 1.000 | 0.000 | 0.000 |
| | emitting | | | | | | |
| | surface | | | | | | |
| Imaging | Incident | 103.500 | 0.000 | −5.030 | 1.000 | 0.000 | 0.000 |
| lens 7 | surface | | | | | | |
| | Light | 107.800 | 0.000 | −5.030 | 1.000 | 0.000 | 0.000 |
| | emitting | | | | | | |
| | surface | | | | | | |
| Mirror M1 | Reflective | 124.127 | 0.000 | −4.860 | 0.652 | 0.000 | 0.759 |
| | surface | | | | | | |

| | | | | | | |
|---|---|---|---|---|---|---|
| Scanned surface | 139.245 | 0.000 | −112.686 | −0.151 | 0.000 | 0.989 |

TABLE 2
Aspheric surface coefficients

| | | Anamorphic lens | | Imaging lens 6 | | Imaging lens 7 | |
|---|---|---|---|---|---|---|---|
| | | | Light | | Light | | Light |
| | | Incident | emitting | Incident | emitting | Incident | emitting |
| | | surface | surface | surface | surface | surface | surface |
| Generatrix | R | ∞ | 3.7169E+01 | −7.1101E+01 | −4.2946E+01 | −4.0000E+03 | 3.5012E+02 |
| | K | — | — | 9.4635E−01 | −5.1550E−01 | 0.0000E+00 | −8.7532E+01 |
| | B1 | — | — | 0.0000E+00 | 0.0000E+00 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | 0.0000E+00 | 0.0000E+00 | 0.0000E+00 |
| | B4 | — | — | −9.1474E−07 | −3.4771E−07 | 0.0000E+00 | −2.0201E−07 |
| | B5 | — | — | 0.0000E+00 | 0.0000E+00 | 0.0000E+00 | 0.0000E+00 |
| | B6 | — | — | 6.7844E−09 | 1.6900E−09 | 0.0000E+00 | 1.6092E−11 |
| | B7 | — | — | 0.0000E+00 | 0.0000E+00 | 0.0000E+00 | 0.0000E+00 |
| | B8 | — | — | −5.7671E−12 | 1.1098E−12 | 0.0000E+00 | −9.3134E−16 |
| | B9 | — | — | 0.0000E+00 | 0.0000E+00 | 0.0000E+00 | 0.0000E+00 |
| | B10 | — | — | 1.6383E−15 | −1.2240E−15 | 0.0000E+00 | 2.5240E−20 |
| Meridian R | r | ∞ | 2.6170E+01 | 2.0000E+01 | 2.5004E+01 | 3.7079E+01 | −1.5401E+02 |
| | E1 | — | — | 0.0000E+00 | 0.0000E+00 | 0.0000E+00 | −1.2778E−07 |
| | E2 | — | — | 0.0000E+00 | 1.5218E−05 | −7.4583E−07 | 1.8131E−06 |
| | E3 | — | — | 0.0000E+00 | 0.0000E+00 | 0.0000E+00 | −3.2397E−09 |
| | E4 | — | — | 0.0000E+00 | 8.4864E−10 | 0.0000E+00 | −3.0410E−10 |
| | E5 | — | — | 0.0000E+00 | 0.0000E+00 | 0.0000E+00 | 1.3388E−12 |
| | E6 | — | — | 0.0000E+00 | −2.5078E−11 | 0.0000E+00 | 3.0818E−14 |
| | E7 | — | — | 0.0000E+00 | 0.0000E+00 | 0.0000E+00 | −2.0088E−16 |
| | E8 | — | — | 0.0000E+00 | 7.6068E−15 | 0.0000E+00 | −1.9542E−18 |
| | E9 | — | — | 0.0000E+00 | 0.0000E+00 | 0.0000E+00 | 9.8586E−21 |
| | E10 | — | — | 0.0000E+00 | 1.6097E−17 | 0.0000E+00 | 5.8119E−23 |
| Noncircular | M (0, 1) | — | — | 0.0000E+00 | −2.1236E−02 | −1.0066E−01 | 2.3151E−02 |
| meridian | M (1, 1) | — | — | 0.0000E+00 | 0.0000E+00 | −2.1291E−04 | −2.0022E−04 |
| | M (2, 1) | — | — | 0.0000E+00 | 3.3214E−05 | −1.3143E−05 | −2.3696E−05 |
| | M (3, 1) | — | — | 0.0000E+00 | 0.0000E+00 | 1.1605E−07 | 1.0558E−07 |
| | M (4, 1) | — | — | 0.0000E+00 | 0.0000E+00 | 1.7651E−09 | 3.6747E−09 |
| | M (5, 1) | — | — | 0.0000E+00 | 0.0000E+00 | −1.6159E−11 | −1.4094E−11 |
| | M (6, 1) | — | — | 0.0000E+00 | 0.0000E+00 | 3.0137E−13 | −3.0524E−13 |
| | M (7, 1) | — | — | 0.0000E+00 | 0.0000E+00 | 1.0611E−15 | 9.7328E−16 |
| | M (8, 1) | — | — | 0.0000E+00 | 0.0000E+00 | −1.3056E−17 | 6.5743E−17 |
| | M (9, 1) | — | — | 0.0000E+00 | 0.0000E+00 | −1.6570E−20 | −1.7277E−20 |
| | M (10, 1) | — | — | 0.0000E+00 | 0.0000E+00 | −8.5362E−22 | −3.9596E−21 |
| Diffractive | C (2, 2) | −7.8466E−03 | — | — | — | — | — |
| surface | C (0, 2) | −8.6690E−03 | — | — | — | — | — |

TABLE 3
Specifications

| | | |
|---|---|---|
| Laser wavelength (nm) | Λ | 790 |
| Incident angle (deg) in main scanning | Am | 78 |
| direction from incident optical | | |
| system to deflector | | |
| Incident angle (deg) in sub scanning | As | 2.7 |
| direction from incident optical | | |
| system to deflector | | |
| Refractive index of anamorphic lens | n2 | 1.524 |
| Refractive index of imaging lens 6 | n6 | 1.524 |
| Refractive index of imaging lens 7 | n7 | 1.524 |
| Diameter of sub-scanning aperture | Z-direction | 2.84 |
| (rectangular shape) (mm) | | |
| Diameter of main-scanning aperture | Y-direction | 3.75 |
| (rectangular shape) (mm) | | |
| Coordinate of rotation axis of | X-direction | −6.03 |
| polygon mirror (mm) | Y-direction | −3.79 |
| (Define coordinates of axial | | |
| deflection point of imaging optical | | |
| system SB as (0, 0, 0)) | | |
| fθ coefficient (mm/rad) | K | 207 |
| Diameter of circumscribed circle | Rp | 20 |
| on coordinate of rotation axis of | | |
| polygon mirror (mm) | | |
| Number of surfaces of polygon mirror | MEN | 4 |
| Maximum scanning angle of view (deg) | Θmax | ±45.12 |
| Image height on scanned surface (mm) | M | ±163 |

Optical arrangements

| | | Incident optical system LB, imaging optical system SB | | | | | |
|---|---|---|---|---|---|---|---|
| | | | | | Direction of optical axis | | |
| | | Coordinates of surfaces | | | (indicated by direction cosine) | | |
| | | X- | Y- | Z- | X | Y | Z |
| | | coordinate | coordinate | coordinate | component | component | component |
| Light source | | 33.582 | 157.991 | −7.617 | 0.208 | 0.977 | −0.047 |
| Anamorphic | Incident | 26.606 | 125.171 | −6.035 | 0.208 | 0.977 | −0.047 |
| lens | surface | | | | | | |
| | Light | 25.983 | 122.240 | −5.893 | 0.208 | 0.977 | −0.047 |
| | emitting | | | | | | |
| | surface | | | | | | |
| Sub-scanning aperture | | 22.837 | 107.438 | −5.180 | 0.208 | 0.978 | 0.000 |
| Main-scanning aperture | | 16.633 | 78.253 | −3.773 | 0.208 | 0.978 | 0.000 |
| Polygon | Deflection | 0.000 | 0.000 | 0.000 | — | — | — |
| mirror | surface | | | | | | |
| Imaging | Incident | 26.000 | 0.000 | 0.000 | 1.000 | 0.000 | 0.000 |
| lens 6 | surface | | | | | | |
| | Light | 34.200 | 0.000 | 0.000 | 1.000 | 0.000 | 0.000 |
| | emitting | | | | | | |
| | surface | | | | | | |
| Mirror M2 | Reflective | 88.828 | 0.000 | 5.632 | 0.958 | 0.000 | 0.287 |
| | surface | | | | | | |
| Imaging | Incident | 60.258 | 0.000 | −11.298 | 0.835 | 0.000 | 0.550 |
| lens 7 | surface | | | | | | |
| | Light | 56.667 | 0.000 | −13.663 | 0.835 | 0.000 | 0.550 |
| | emitting | | | | | | |
| | surface | | | | | | |
| Mirror M3 | Reflective | 43.728 | −3.500 | −22.446 | 0.917 | 0.000 | −0.399 |
| | surface | | | | | | |

| | | | | | | |
|---|---|---|---|---|---|---|
| Scanned surface | 56.245 | 0.000 | −112.686 | 0.167 | 0.000 | −0.986 |

TABLE 4
Aspheric surface coefficients

| | | Anamorphic lens | | Imaging lens 6 | | Imaging lens 7 | |
|---|---|---|---|---|---|---|---|
| | | | Light | | Light | | Light |
| | | Incident | emitting | Incident | emitting | Incident | emitting |
| | | surface | surface | surface | surface | surface | surface |
| Generatrix | R | ∞ | 3.7169E+01 | −7.1101E+01 | −4.3800E+01 | −4.0000E+03 | −3.7997E+02 |
| | K | — | — | 9.4635E−01 | −9.3213E−01 | 0.0000E+00 | −7.4124E+01 |
| | B1 | — | — | 0.0000E+00 | 0.0000E+00 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | 0.0000E+00 | 0.0000E+00 | 0.0000E+00 |
| | B4 | — | — | −9.1474E−07 | −1.3549E−06 | 0.0000E+00 | 1.3315E−07 |
| | B5 | — | — | 0.0000E+00 | 0.0000E+00 | 0.0000E+00 | 0.0000E+00 |
| | B6 | — | — | 6.7844E−09 | 1.7187E−09 | 0.0000E+00 | −7.2059E−12 |
| | B7 | — | — | 0.0000E+00 | 0.0000E+00 | 0.0000E+00 | 0.0000E+00 |
| | B8 | — | — | −5.7671E−12 | 8.7615E−13 | 0.0000E+00 | 3.0701E−16 |
| | B9 | — | — | 0.0000E+00 | 0.0000E+00 | 0.0000E+00 | 0.0000E+00 |
| | B10 | — | — | 1.6383E−15 | −1.0692E−15 | 0.0000E+00 | −6.0892E−21 |
| Meridian R | r | ∞ | 2.6170E+01 | 2.0000E+01 | 5.5261E+01 | −3.7426E+01 | 2.4999E+02 |
| | E1 | — | — | 0.0000E+00 | 0.0000E+00 | 0.0000E+00 | −9.4098E−09 |
| | E2 | — | — | 0.0000E+00 | 6.8936E−06 | 3.4815E−07 | −1.4464E−06 |
| | E3 | — | — | 0.0000E+00 | 0.0000E+00 | 0.0000E+00 | 1.6158E−09 |
| | E4 | — | — | 0.0000E+00 | 8.4247E−08 | 0.0000E+00 | 2.7926E−10 |
| | E5 | — | — | 0.0000E+00 | 0.0000E+00 | 0.0000E+00 | −4.7207E−13 |
| | E6 | — | — | 0.0000E+00 | −2.6794E−10 | 0.0000E+00 | −4.4548E−14 |
| | E7 | — | — | 0.0000E+00 | 0.0000E+00 | 0.0000E+00 | 5.3540E−17 |
| | E8 | — | — | 0.0000E+00 | 3.4364E−13 | 0.0000E+00 | 3.9357E−18 |
| | E9 | — | — | 0.0000E+00 | 0.0000E+00 | 0.0000E+00 | −2.0275E−21 |
| | E10 | — | — | 0.0000E+00 | −1.5385E−16 | 0.0000E+00 | −1.3630E−22 |
| Noncircular | M (0, 1) | — | — | 0.0000E+00 | 7.6609E−02 | −1.2108E−01 | 5.8011E−02 |
| meridian | M (1, 1) | — | — | 0.0000E+00 | 0.0000E+00 | −2.1291E−04 | −2.0022E−04 |
| | M (2, 1) | — | — | 0.0000E+00 | −3.9065E−05 | −1.1106E−05 | −2.2919E−05 |
| | M (3, 1) | — | — | 0.0000E+00 | 0.0000E+00 | 1.4189E−07 | 1.2876E−07 |
| | M (4, 1) | — | — | 0.0000E+00 | 0.0000E+00 | 5.5567E−10 | 2.6270E−09 |
| | M (5, 1) | — | — | 0.0000E+00 | 0.0000E+00 | −2.5886E−11 | −2.1739E−11 |
| | M (6, 1) | — | — | 0.0000E+00 | 0.0000E+00 | 2.4589E−13 | −2.0667E−13 |
| | M (7, 1) | — | — | 0.0000E+00 | 0.0000E+00 | 2.1501E−15 | 1.6753E−15 |
| | M (8, 1) | — | — | 0.0000E+00 | 0.0000E+00 | −1.1817E−17 | 3.2093E−17 |
| | M (9, 1) | — | — | 0.0000E+00 | 0.0000E+00 | −6.1299E−20 | −4.1993E−20 |
| | M (10, 1) | — | — | 0.0000E+00 | 0.0000E+00 | −9.7167E−23 | −1.4874E−21 |
| Diffractive | C (2, 2) | −7.8466E−03 | — | — | — | — | — |
| surface | C (0, 2) | −8.6690E−03 | — | — | — | — | — |

The defocusing due to temperature change is suppressed by a diffractive surface provided with the incident surface of each of the anamorphic lenses 2A and 2B. However, the effect of the present exemplary embodiment is not limited to this configuration. The incident surfaces of the anamorphic lenses 2A and 2B are rotationally asymmetric diffractive surfaces, and the phase function (P of a diffraction grating is represented by the following equation.

$$Φ = \frac{2 π}{k λ} + {\sum }_{i , j} {C}_{i , j} {y}^{i} {z}^{j} \qquad [ Equation 1 ]$$

Here, k is a diffraction order, and in the present exemplary embodiment, k=1. In addition, λ is a wavelength, and in the present exemplary embodiment, λ=790 nm.

The generatrix shape (meridional shape: the shape of the lens surface in the main-scanning cross section) of each of the lens surfaces of the lenses 6A and 6B and the lenses 7A and 7B according to the present exemplary embodiment is an aspherical shape that is represented by a function up to the tenth degree as in the following equation.

$$x = \frac{{y}^{2} / R}{1 + \sqrt{1 - ( 1 + K ) {( y / R )}^{2}}} + {\sum }_{i} {B}_{i} {y}^{i} \qquad [ Equation 2 ]$$

Here, the optical axis direction is the x-axis, the axis orthogonal to the optical axis in the main-scanning cross section the y-axis, and the axis orthogonal to the optical axis in the sub-scanning cross section the z-axis, the three axes of which the origin is the point of intersection of the optical axis with each lens surface the respective optical axis. The light traveling direction on the X axis is the +x direction. The light source side of the optical axis corresponds to the +y direction. Further, R is a curvature radius of generatrix (meridional line), K is an eccentricity, and Bi (I=1, 2, . . . , 10) is an aspherical coefficient.

The meridional shape (the shape of the lens surface in the sub-scanning cross section at an image height) of each of the lens surfaces of the lenses 6A and 6B and the lenses 7A and 7B according to the present exemplary embodiment is an aspherical shape that is represented by the following equation.

$$S = \frac{{z}^{2} / {r}^{′}}{1 + \sqrt{1 - {( z / {r}^{′} )}^{2}}} + {\sum }_{i , j} {m}_{i , j} {y}^{i} {z}^{j} \qquad [ Equation 3 ]$$

Here, S is a meridional shape defined in a plane that includes a normal line of the generatrix at the positions in a generatrix direction and is perpendicular to the main-scanning cross section, and m_{i, j} (i=1, 2, . . . , 10, and j=1) is an aspherical coefficient. The term including a linear function of Z is a term that gives the amount of tilt in a meridional direction.

A curvature radius r′ of the meridian is continuously changed according to the Y coordinates of the lens surface as represented by the following expression.

$$\frac{1}{{r}^{′}} = \frac{1}{r} + {\sum }_{i} {E}_{i} {y}^{i} \qquad [ Equation 4 ]$$

Here, r is a curvature radius of the meridian on the optical axis, and Ei (i=1, 2, . . . , 10) is a change coefficient of the meridian.

The effect of the optical scanning apparatus 100 according to the present exemplary embodiment will now be described.

In the optical scanning apparatus 100 according to the present exemplary embodiment, as shown in Tables 2 and 4, light emitting surfaces of the lenses 6A and 6B are surfaces (meridional tilt surfaces) with aspherical coefficients m_{i, j}≠0. The meridional tilt surface is an optical surface in which the normal line on the generatrix is tilted with respect to the optical axis (non-parallel to the optical axis) in the sub-scanning cross section including the optical axis. The generatrix herein is an intersection line between the optical surface and the main-scanning cross section. Since y=0 on the optical axis, the amount of meridional tilt (tilt of the normal line with respect to the optical axis on the generatrix) in the sub-scanning cross section including the optical axis is represented by m_{0, 1}. Further, the meridional tilt surface (a meridional tilt change surface) has aspherical coefficients of m_{2, 1}, and the amount of meridional tilt of each of the optical surfaces is changed according to the position y in the main scanning direction. A change of the amount of meridional tilt can change the angle of the light beam passed through the meridional tilt surface in the sub-scanning cross section. Compared with a conventional lens without a meridional tilt surface, the angles of the light beams RA and RB passed through the lenses 6A and 6B according to the present exemplary embodiment, respectively, in the sub-scanning cross section from the reference surface can be increased. The mirror M2 can thus be arranged near the lenses 6A and 6B while avoiding interference with the light beam RA, downsizing the optical scanning apparatus 100.

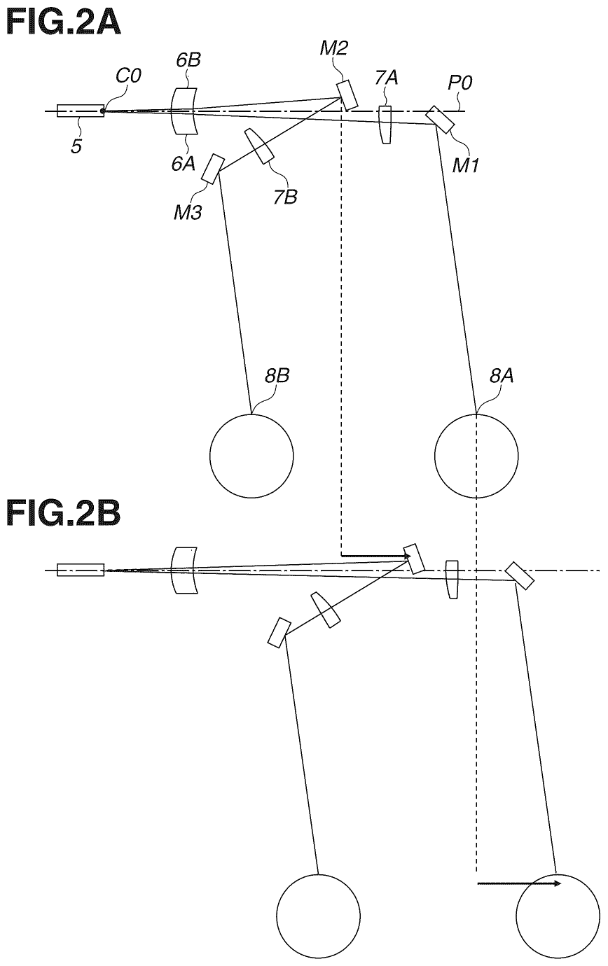

Here, if the incident light emitting surfaces of the lenses 6A and 6B are not formed as meridional tilt surfaces, the mirror M2 and the light beam RA will interfere with each other. As illustrated in FIG. 2B, in a comparative example (a conventional example), the mirror M2 is moved in a direction away from the lenses 6A and 6B in order to arrange the mirror M2 while avoiding the interference. This increases the size of the optical scanning apparatus 100. Further, the movement of the mirror M2 increases the distance between the deflector 5 and the scanned surface 8A, increasing the size of the image formation apparatus provided with the mirror M2.

Not all of the incident and light emitting surfaces of the lenses 6A and 6B can be meridional tilt surfaces. The above-described effect can be produced as long as at least one of these four optical surfaces is a meridional tilt surface. However, the light emitting surfaces of the lenses 6A and 6B are desirably meridional tilt surfaces, and the incident and light emitting surfaces of the lenses 6A and 6B are further desirably meridional tilt surfaces. The incident surfaces of the lenses 6A and 6B desirably have the same shape as each other in the effective regions thereof. This configuration can facilitate manufacturing the lenses.

As illustrated in FIG. 2A, the lenses 6A and 6B according to the present exemplary embodiment are multistage lenses arranged in the sub scanning direction and integrally formed with each other. In this way, the light beams RA and RB can share the lens, which reduces the number of the lenses used. This enables downsizing and cutting cost of the optical scanning apparatus 100. However, the lenses 6A and 6B can be separate components from each other as appropriate.

In the multistage lens according to the present exemplary embodiment, at least one of the incident and light emitting surfaces of the lenses 6A and 6B has a lens surface shape asymmetric with respect to the reference surface P0 in the sub scanning direction, and the upper shape and the lower shape thereof with respect to the reference surface P0 differ from each other.

In the present exemplary embodiment, the value of an aspherical coefficient m_{0, 1} that corresponds to the amount of meridional tilt on the optical axis (y=0) of the light emitting surface of the lens 6A (the first refractive element) is m1_{0, 1}, and the value of an aspherical coefficient m_{0, 1} that corresponds to the amount of meridional tilt on the optical axis of the light emitting surface of the lens 6B (the second refractive element) is m3_{0, 1}. In this case, m1_{0, 1} is desirably smaller than m3_{0, 1}. This allows appropriate settings made of amounts of meridional tilt of the light emitting surfaces of the lens 6A and 6B, which facilitates improvement in optical performance and downsizing. The light emitting surface of the lens 6A corresponds to the outer optical path (a far side from the deflector 5) in which the light is reflected once, and the light emitting surface of the lens 6B corresponds to the inner optical path (nearer the deflector 5) in which the light is reflected twice.

Further, it is desirable to satisfy the following inequality (1).

$$0.01 < \vert m {1}_{0 , 1} / m {3}_{0 , 1} \vert < 100. \qquad ( 1 )$$

If the inequality (1) is not satisfied, the difference in the amount of meridional tilt between the lenses 6A and 6B will be increased, providing increased difference in optical performance between the imaging optical systems SA and SB, which can cause unintended color with the optical scanning apparatus 100 used in the image formation apparatus.

Further, it is desirable to satisfy the following inequality (1a).

$$0.1 < \vert m {1}_{0 , 1} / m {3}_{0 , 1} \vert < 10. \qquad ( 1 a )$$

As shown in Tables. 2 and 4, the aspherical coefficients m1_{0, 1} and m3_{0, 1}, which are the amounts of meridional tilt on the axis (y=0) of the light emitting surfaces of the lenses 6A and 6B according to the present exemplary embodiment, are −2.1236E-02 and 7.6609E-2, respectively, and satisfy the inequalities (1) and (1a). Here, “E-x” represents “×10^{-x}”.

The signs of m1_{0, 1}, and m3_{0, 1} desirably differ from each other. Thus, an inequality m1_{0, 1}/m3_{0, 1}<0 is desirably satisfied. This makes the directions of the amounts of meridional tilt on the axis different from each other to increase the angles of the light beams RA and RB respectively passed through the lenses 6A and 6B in the sub-scanning cross section from the reference surface, allowing the mirror M2 to be arranged near the lenses 6A and 6B, facilitating downsizing the optical scanning apparatus 100. If the aspherical coefficients have the same sign as each other, the directions of the amounts of meridional tilt on the axis will be the same as each other, which can cause interference between the mirror M2 and the light beam RA. Thus, it is further desirable that the sign of m1_{0, 1} of the light emitting surface of the lens 6A, which corresponds to the outer optical path, be negative and that the sign of m3_{0, 1} of the light emitting surface of the lens 6B, which corresponds to the inner optical path, be positive.

In the optical scanning apparatus 100 according to the present exemplary embodiment, when distances (optical distances) on the optical axis from the deflection point C0 to the lens 7A (the second refractive element) and the lens 7B (the fourth refractive element) are denoted by L1 and L2, respectively, the following inequality (2) is satisfied. In the present exemplary embodiment, “optical” means “in a state where an optical path is provided”.

$$L 1 / L 2 \neq 1 \qquad ( 2 )$$

The inequality (2) indicates that the distances on the optical axis from the axial deflection point to the second and fourth refractive elements (to the respective incident surfaces) differ from each other. With the inequality (2) satisfied, the lenses 7A and 7B are arranged such that the optical positions from the deflection point C0 to the lenses 7A and 7B are different positions from each other. This configuration can increase a degree of freedom in arrangement and downsize the optical scanning apparatus 100 while avoiding interference.

In addition, in the optical scanning apparatus 100 according to the present exemplary embodiment, the following inequality (3) is satisfied.

$$L 1 / L 2 < 1. \qquad ( 3 )$$

The inequality (3) indicates that the distance L1 on the optical axis from the axial deflection point to the second refractive element is shorter than the distance L2 on the optical axis from the axial deflection point to the fourth refractive element. In the imaging optical systems SA and SB according to the present exemplary embodiment, the imaging optical system SA has a smaller number of mirrors than the imaging optical system SB does, and there are fewer restrictions on the arrangement of lenses and mirrors. Thus, compared with the lens 7B, the lens 7A is disposed at a position near the deflection point C0 to satisfy the inequality (3). As a result, the size of the lens 7A in the main scanning direction can be smaller than that of the lens 7B, which downsizes the optical scanning apparatus 100. In addition, the reduced size of the lens 7A in the main scanning direction can reduce deformation of the lens shape, such as warp, preventing image deterioration.

Furthermore, it is desirable to satisfy the following inequality (3a).

$$0.5 < L 1 / L 2 < 1. \qquad ( 3 a )$$

If L1/L2 falls below the lower limit of the inequality (3a), the optical distances L1 and L2 on the optical axis from the deflection point C0 to the lenses 7A and 7B will be increased, increasing the difference in the optical performance between the imaging optical systems SA and SB, which can cause unintended color with the optical scanning apparatus 100 used in the image formation apparatus.

Moreover, it is desirable to satisfy the following inequality (3b).

$$0.8 < L 1 / L 2 < 0.9 \qquad ( 3 b )$$

As shown in Table 1 and Table 3, the optical distances L1 and L2 on the optical axis from the deflection point C0 to the lenses 7A and 7B according to the present exemplary embodiment are 103.5 mm and 122 mm, respectively, and satisfy the inequalities (2), (3), (3a), and (3b).

As described above, in the optical scanning apparatus 100 according to the present exemplary embodiment, the lenses and the mirrors arranged to satisfy the above-described relationships can downsize the optical scanning apparatus 100 while avoiding increase in the distance between the photosensitive members of the image formation apparatus provided with the optical scanning apparatus 100.

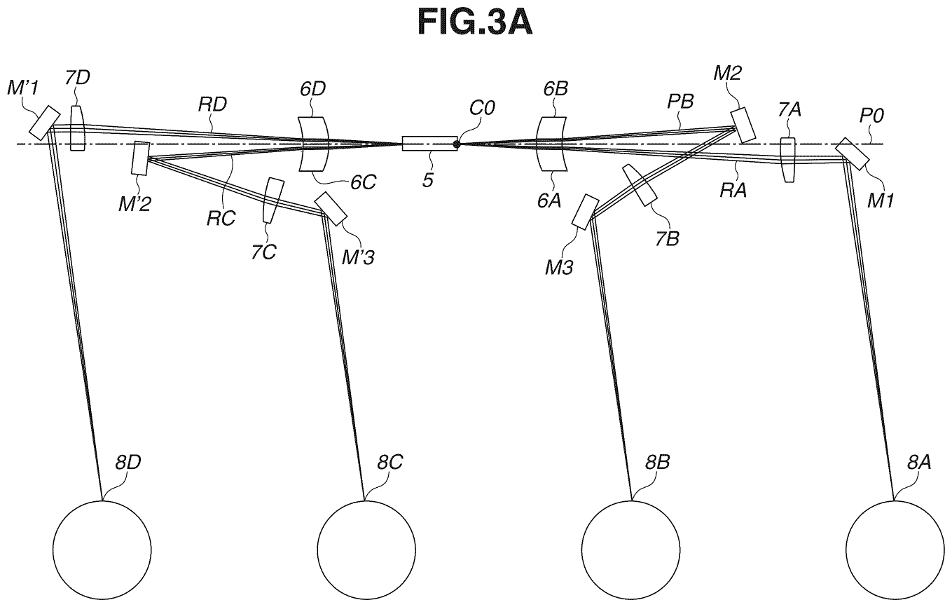

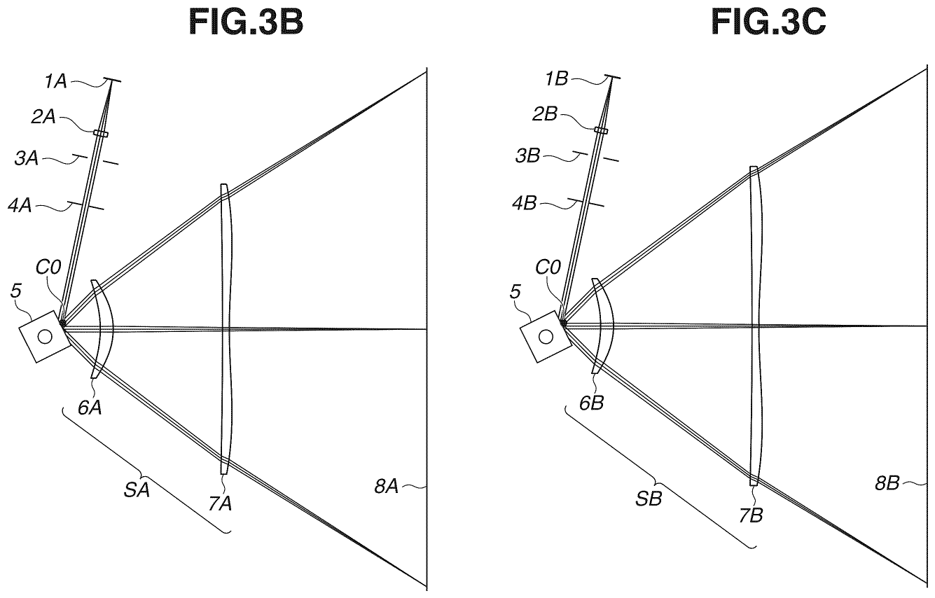

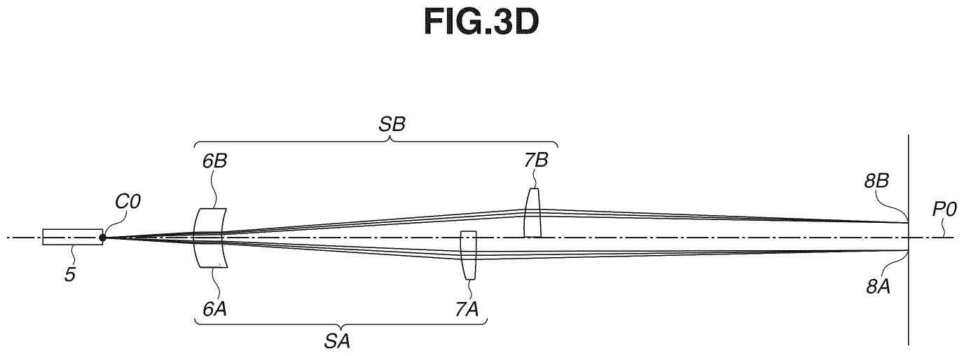

A second exemplary embodiment will be described. FIG. 3A is a sub-scanning cross-sectional view of main components of an optical scanning apparatus 200 according to the second exemplary embodiment. FIG. 3B is a light path view on a main-scanning cross section of the main components of the optical scanning apparatus 200 according to the second exemplary embodiment. FIG. 3C is a light path view on the sub-scanning cross section of the main components of the optical scanning apparatus 200 according to the second exemplary embodiment.

The optical scanning apparatus 200 according to the present exemplary embodiment includes a light source 1A (a first light source), a light source 1B (a second light source), a light source 1C (a third light source), a light source 1D (a fourth light source), incident optical systems LA, LB, LC, and LD, a deflector 5, an imaging optical system SA (a first imaging optical system), an imaging optical system SB (a second imaging optical system), an imaging optical system SC (a third imaging optical system), an imaging optical system SD (a fourth imaging optical system), and folding mirrors M1, M2, M3, M′1, M′2, and M′3.

The light sources 1A and 1B, the incident optical systems LA and LB, the deflector 5, the imaging optical systems SA and SB, and the mirrors M1, M2, and M3 in the optical scanning apparatus 200 have similar configurations to those in the optical scanning apparatus 100 according to the first exemplary embodiment. Thus, the description thereon will be omitted.

Semiconductor lasers are used as the light sources 1A, 1B, 1C, and 1D. The number of light emitting points of the light sources 1A, 1B, 1C, and 1D can be one or more.

The incident optical systems LA and LB in the present exemplary embodiment have similar configurations and optical actions to those of the incident optical systems LA and LB according to the first exemplary embodiment. In addition, the incident optical systems LC and LD in the present exemplary embodiment have similar configurations and optical actions to those of the imaging optical systems SA and SB according to the present exemplary embodiment.

In the optical scanning apparatus 200 according to the present exemplary embodiment, a pair of the imaging optical systems SA and SB and a pair of the imaging optical systems SC and SD are arranged such that the deflector 5 is therebetween. The single deflector 5 deflects four light beams RA (a first light beam), RB (a second light beam), a RC (a third light beam), and RD (a fourth light beam) to scans a scanned surface 8A (a first scanned surface), a scanned surface 8B (a second scanned surface), a scanned surface 8C (a third scanned surface), and a scanned surface 8D (a fourth scanned surface), respectively. The optical scanning apparatus 200 according to the present exemplary embodiment uses a so-called sub-scanning oblique incident optical system in which the light beams share and are obliquely incident on the single deflector 5 in the sub scanning direction. The sub-scanning oblique incident optical system has an advantage that deflected and reflected light beams can be separated without enlarging the deflection and reflection surface of the optical deflector in the sub scanning direction.

In the imaging optical system SA, the deflected light beam RA deflected and reflected by a deflection and reflection surface 5A of the deflector 5 as a deflection unit passes through a lens 6A (a first refractive element) and a lens 7A (a second refractive element). Thereafter, the deflected light beam RA is folded by the folding mirror M1 and guided to the scanned surface 8A. In addition, in the imaging optical system SB, the deflected light beam RB deflected and reflected by the deflection and reflection surface 5A of the deflector 5 passes through a lens 6B (a third refractive element). Thereafter, the deflected light beam RB is folded by the mirror M2 and passes through a lens 7B (a fourth refractive element). Then, the deflected light beam RB is folded by the mirror M3 and reaches the scanned surface 8B.

Also, in the imaging optical system SD (SC), the optical paths are routed in a similar manner to those in the imaging optical system SA (SB). The deflected light beam RD deflected and reflected by a deflection and reflection surface 5′A of the deflector 5 passes through a lens 6D (a seventh refractive element) and a lens 7D (an eighth refractive element). Thereafter, the deflected light beam RD is folded by the folding mirror M′1 and guided to the scanned surface 8D. The deflected light beam RC deflected and reflected by the deflection and reflection surface 5′A of the deflector 5 passes through a lens 6C (a fifth refractive element) and is thereafter folded by the folding mirror M′2. Then, the deflected light beam RC passes through a lens 7C (a sixth refractive element) and is thereafter folded by the folding mirror M′3. In this way, the deflected light beam RC is guided to the scanned surface 8C.

The imaging optical systems SA and SB in the present exemplary embodiment have similar configurations and optical actions to those of the imaging optical systems SA and SB according to the first exemplary embodiment, respectively. In addition, the imaging optical systems SC and SD in the present exemplary embodiment have similar configurations and optical actions to those of the imaging optical systems SB and SA in the present exemplary embodiment, respectively.

Tables 5 to 8 below will show specifications, optical arrangements, and lens surface shapes of the optical scanning apparatus 200 according to the present exemplary embodiment. Here, Table 5 shows specifications and lens arrangements of the incident optical system LA (LD) and the imaging optical system SA (SD). Table 6 shows lens surface shapes of the incident optical system LA (LD) and the imaging optical system SA (SD). Table 7 shows specifications and lens arrangements of the incident optical system LB (LC) and the imaging optical system SB (SC). Table 8 shows lens surface shapes of the incident optical system LB (LC) and the imaging optical system SB (SC). Some cells of the optical arrangements in Tables 5 and 7 show the coordinates of reflection points of the light beams RA (RD) and RB (RC) on the mirrors that travel toward the image center (the axial image height) of the scanned surface in the main scanning direction.

In Tables 6 and 8, an axis in an optical axis direction, an axis orthogonal to the optical axis in the main-scanning cross section, and an axis orthogonal to the optical axis in the sub-scanning cross section are an x-axis, a y-axis, and a z-axis, respectively, the three axes of which the origin is the point of intersection of the optical axis with each lens surface. The light travel direction on the x-axis is the +x direction. The light source side of the optical axis on the Y axis corresponds to the +y direction. In Tables 6 and 8, “E-x” represents “×10^{-x}”.

TABLE 5
Specifications

| | | |
|---|---|---|
| Laser wavelength (nm) | λ | 790 |
| Incident angle (deg) in main scanning | αm | 78 |
| direction from incident optical | | |
| system to deflector | | |
| Incident angle (deg) in sub scanning | αs | 2.7 |
| direction from incident optical | | |
| system to deflector | | |
| Refractive index of anamorphic lens | n2 | 1.524 |
| Refractive index of imaging lens 6 | n6 | 1.524 |
| Refractive index of imaging lens 7 | n7 | 1.524 |
| Diameter of sub-scanning aperture | Z-direction | 2.84 |
| (rectangular shape) (mm) | | |
| Diameter of main-scanning aperture | Y-direction | 2.70 |
| (rectangular shape) (mm) | | |
| Coordinate of rotation axis of | X-direction | −6.03 |
| polygon mirror (mm) | Y-direction | −3.79 |
| (Define coordinates of axial | | |
| deflection point of imaging optical | | |
| system SA as (0, 0, 0)) | | |
| fθ coefficient (mm/rad) | k | 220 |
| Diameter of circumscribed circle | Rp | 20 |
| on coordinate of rotation axis of | | |
| polygon mirror (mm) | | |
| Number of surfaces of polygon mirror | MEN | 4 |
| Maximum scanning angle of view (deg) | θmax | ±42.45 |
| Image height on scanned surface (mm) | W | ±163 |

Optical arrangements

| | | Incident optical system LA, imaging optical system SA | | | | | |
|---|---|---|---|---|---|---|---|
| | | | | | Direction of optical axis | | |
| | | Coordinates of surfaces | | | (indicated as direction cosine) | | |
| | | X- | Y- | Z- | X | Y | Z |
| | | coordinate | coordinate | coordinate | component | component | component |
| Light source | | 33.582 | 157.991 | 7.617 | 0.208 | 0.977 | 0.047 |
| Anamorphic | Incident | 26.606 | 125.171 | 6.035 | 0.208 | 0.977 | 0.047 |
| lens | surface | | | | | | |
| | Light | 25.983 | 122.240 | 5.893 | 0.208 | 0.977 | 0.047 |
| | emitting | | | | | | |
| | surface | | | | | | |
| Sub-scanning aperture | | 22.006 | 103.529 | 4.991 | 0.208 | 0.978 | 0.000 |
| Main-scanning aperture | | 16.633 | 78.253 | 3.773 | 0.208 | 0.978 | 0.000 |
| Polygon | Deflection | 0.000 | 0.000 | 0.000 | — | — | — |
| mirror | surface | | | | | | |
| Imaging | Incident | 26.000 | 0.000 | 0.000 | 1.000 | 0.000 | 0.000 |
| lens 6 | surface | | | | | | |
| | Light | 34.200 | 0.000 | 0.000 | 1.000 | 0.000 | 0.000 |
| | emitting | | | | | | |
| | surface | | | | | | |
| Imaging | Incident | 98.800 | 0.000 | −5.960 | 1.000 | 0.000 | 0.000 |
| lens 7 | surface | | | | | | |
| | Light | 100.800 | 0.000 | −5.960 | 1.000 | 0.000 | 0.000 |
| | emitting | | | | | | |
| | surface | | | | | | |
| Mirror M1 | Reflective | 105.100 | 0.000 | −5.960 | 1.000 | 0.000 | 0.000 |
| | surface | | | | | | |

| | | | | | | |
|---|---|---|---|---|---|---|
| Surface to be scanned | 139.245 | 0.000 | −112.686 | 0.028 | 0.000 | 1.000 |

Optical arrangements

| | | Incident optical system LD, imaging optical system SD | | | | | |
|---|---|---|---|---|---|---|---|
| | | | | | Direction of optical axis | | |
| | | Coordinates of surfaces | | | (indicated as direction cosine) | | |
| | | X- | Y- | Z- | X | Y | Z |
| | | coordinate | coordinate | coordinate | component | component | component |
| Light source | | −45.642 | 157.991 | −7.617 | −0.208 | 1.977 | −0.047 |
| Anamorphic | Incident | −38.666 | 125.171 | −6.035 | −0.208 | 0.977 | −0.047 |
| lens | surface | | | | | | |
| | Light | −38.043 | 122.240 | −5.893 | −0.208 | 0.977 | −0.047 |
| | emitting | | | | | | |
| | surface | | | | | | |
| Sub-scanning aperture | | −34.066 | 103.529 | −4.991 | −0.208 | 0.978 | 0.000 |
| Main-scanning aperture | | −28.693 | 78.253 | −3.773 | −0.208 | 0.978 | 0.000 |
| Polygon | Deflection | 0.000 | 0.000 | 0.000 | — | — | — |
| mirror | surface | | | | | | |
| Imaging | Incident | −38.060 | 0.000 | 0.000 | −1.000 | 0.000 | 0.000 |
| lens 6 | surface | | | | | | |
| | Light | −46.260 | 0.000 | 0.000 | −1.000 | 0.000 | 0.000 |
| | emitting | | | | | | |
| | surface | | | | | | |
| Imaging | Incident | −198.260 | 0.000 | 0.000 | −1.000 | 0.000 | 0.000 |
| lens 7 | surface | | | | | | |
| | Light | −112.860 | 0.000 | 5.960 | −1.000 | 0.000 | 0.000 |
| | emitting | | | | | | |
| | surface | | | | | | |
| Mirror M1 | Reflective | −117.160 | 0.000 | 5.960 | −1.000 | 0.000 | 0.000 |
| | surface | | | | | | |

| | | | | | | |
|---|---|---|---|---|---|---|
| Surface to be scanned | −109.755 | 0.000 | −112.686 | 0.028 | 0.000 | 1.000 |

TABLE 6
Aspheric surface coefficients

| | | Anamorphic lens | | Imaging lens 6 | | Imaging lens 7 | |
|---|---|---|---|---|---|---|---|
| | | | Light | | Light | | Light |
| | | Incident | emitting | Incident | emitting | Incident | emitting |
| | | surface | surface | surface | surface | surface | surface |
| Generatrix | R | ∞ | 3.7169E+01 | −7.1974E+01 | −4.3211E+01 | −4.0000E+03 | 3.4560E+02 |
| | K | — | — | 8.9207E−01 | −5.7266E−01 | 0.0000E+00 | −9.0215E+01 |
| | B1 | — | — | 0.0000E+00 | 0.0000E+00 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | 0.0000E+00 | 0.0000E+00 | 0.0000E+00 |
| | B4 | — | — | −7.6122E−07 | −1.9946E−07 | 0.0000E+00 | −2.1656E−07 |
| | B5 | — | — | 0.0000E+00 | 0.0000E+00 | 0.0000E+00 | 0.0000E+00 |
| | B6 | — | — | 6.7890E−09 | 1.6448E−09 | 0.0000E+00 | 1.8005E−11 |
| | B7 | — | — | 0.0000E+00 | 0.0000E+00 | 0.0000E+00 | 0.0000E+00 |
| | B8 | — | — | −5.8886E−12 | 1.2724E−12 | 0.0000E+00 | −1.0687E−15 |
| | B9 | — | — | 0.0000E+00 | 0.0000E+00 | 0.0000E+00 | 0.0000E+00 |
| | B10 | — | — | 1.6170E−15 | −1.4177E−15 | 0.0000E+00 | 2.9833E−20 |
| Meridian R | r | ∞ | 2.6170E+01 | 2.0000E+01 | 2.0586E+01 | 2.6855E+01 | 2.9402E+02 |
| | E1 | — | — | 0.0000E+00 | 0.0000E+00 | 0.0000E+00 | 1.9697E−07 |
| | E2 | — | — | 0.0000E+00 | 1.5580E−05 | −5.1442E−06 | −2.3677E−06 |
| | E3 | — | — | 0.0000E+00 | 0.0000E+00 | 0.0000E+00 | −3.4436E−09 |
| | E4 | — | — | 0.0000E+00 | −3.3937E−08 | 0.0000E+00 | −2.4684E−10 |
| | E5 | — | — | 0.0000E+00 | 0.0000E+00 | 0.0000E+00 | 1.4997E−12 |
| | E6 | — | — | 0.0000E+00 | 3.9640E−11 | 0.0000E+00 | 1.6924E−14 |
| | E7 | — | — | 0.0000E+00 | 0.0000E+00 | 0.0000E+00 | −2.5044E−16 |
| | E8 | — | — | 0.0000E+00 | −6.5582E−14 | 0.0000E+00 | −1.7952E−18 |
| | E9 | — | — | 0.0000E+00 | 0.0000E+00 | 0.0000E+00 | 1.4054E−20 |
| | E10 | — | — | 0.0000E+00 | 5.4011E−17 | 0.0000E+00 | 7.1174E−23 |
| Noncircular | M (0, 1) | — | — | 0.0000E+00 | −3.9283E−02 | −1.5136E−01 | 1.0716E−02 |
| meridian | M (1, 1) | — | — | 0.0000E+00 | 0.0000E+00 | −5.6381E−06 | 2.9831E−06 |
| | M (2, 1) | — | — | 0.0000E+00 | 3.6758E−05 | −2.6037E−05 | −4.0016E−05 |
| | M (3, 1) | — | — | 0.0000E+00 | 0.0000E+00 | 1.3125E−07 | 1.1748E−07 |
| | M (4, 1) | — | — | 0.0000E+00 | 0.0000E+00 | 5.6889E−09 | 7.9090E−09 |
| | M (5, 1) | — | — | 0.0000E+00 | 0.0000E+00 | −3.8269E−11 | −3.1453E−11 |
| | M (6, 1) | — | — | 0.0000E+00 | 0.0000E+00 | 8.3400E−14 | −6.6668E−13 |
| | M (7, 1) | — | — | 0.0000E+00 | 0.0000E+00 | 5.1339E−15 | 3.8471E−15 |
| | M (8, 1) | — | — | 0.0000E+00 | 0.0000E+00 | −2.8936E−17 | 8.3073E−17 |
| | M (9, 1) | — | — | 0.0000E+00 | 0.0000E+00 | −2.2022E−19 | −1.3738E−19 |
| | M (10, 1) | — | — | 0.0000E+00 | 0.0000E+00 | −5.5171E−22 | −5.8207E−21 |
| Diffractive | C (2, 2) | −7.8466E−03 | — | — | — | — | — |
| surface | C (0, 2) | −8.6690E−03 | — | — | — | — | — |

TABLE 7
Specifications

| | | |
|---|---|---|
| Laser wavelength (nm) | λ | 790 |
| Incident angle (deg) in main scanning | αm | 78 |
| direction from incident optical | | |
| system to deflector | | |
| Incident angle (deg) in sub scanning | αs | 2.7 |
| direction from incident optical | | |
| system to deflector | | |
| Refractive index of anamorphic lens | n2 | 1.524 |
| Refractive index of imaging lens 6 | n6 | 1.524 |
| Refractive index of imaging lens 7 | n7 | 1.524 |
| Diameter of sub-scanning aperture | Z-direction | 2.84 |
| (rectangular shape) (mm) | | |
| Diameter of main-scanning aperture | Y-direction | 3.75 |
| (rectangular shape) (mm) | | |
| Coordinate of rotation axis of | X-direction | −6.03 |
| polygon mirror (mm) | Y-direction | −3.79 |
| (Define coordinates of axial | | |
| deflection point of imaging optical | | |
| system SB as (0, 0, 0)) | | |
| fθ coefficient (mm/rad) | k | 207 |
| Diameter of circumscribed circle | Rp | 20 |
| on coordinate of rotation axis of | | |
| polygon mirror (mm) | | |
| Number of surfaces of polygon mirror | MEN | 4 |
| Maximum scanning view angle (deg) | θmax | ±45.12 |
| Image height on scanned surface (mm) | W | ±163 |

Optical arrangements

| | | Incident optical system LB, imaging optical system SB | | | | | |
|---|---|---|---|---|---|---|---|
| | | | | | Direction of optical axis | | |
| | | Coordinates of surfaces | | | (indicated as direction cosine) | | |
| | | X- | Y- | Z- | X | Y | Z |
| | | coordinate | coordinate | coordinate | component | component | component |
| Light source | | 33.582 | 157.991 | −7.617 | 0.208 | 0.977 | −0.047 |
| Anamorphic | Incident | 26.606 | 125.171 | −6.035 | 0.208 | 0.977 | −0.047 |
| lens | surface | | | | | | |
| | Light | 25.983 | 122.240 | −5.893 | 0.208 | 0.977 | −0.047 |
| | emitting | | | | | | |
| | surface | | | | | | |
| Sub-scanning aperture | | 22.006 | 103.529 | −4.991 | 0.208 | 0.978 | 0.000 |
| Main-scanning aperture | | 16.633 | 78.253 | −3.773 | 0.208 | 0.978 | 0.000 |
| Polygon | Deflection | 0.000 | 0.000 | 0.000 | — | — | — |
| mirror | surface | | | | | | |
| Imaging | Incident | 26.000 | 0.000 | 0.000 | 1.000 | 0.000 | 0.000 |
| lens 6 | surface | | | | | | |
| | Light | 34.200 | 0.000 | 0.000 | 1.000 | 0.000 | 0.000 |
| | emitting | | | | | | |
| | surface | | | | | | |
| Mirror M2 | Reflective | 89.837 | 0.000 | 5.632 | 0.947 | 0.000 | 0.320 |
| | surface | | | | | | |
| Imaging | Incident | 63.792 | 0.000 | −9.925 | 0.795 | 0.000 | 0.607 |
| lens 7 | surface | | | | | | |
| | Light | 62.185 | 0.000 | −11.150 | 0.795 | 0.000 | 0.607 |
| | emitting | | | | | | |
| | surface | | | | | | |
| Mirro M3 | Reflective | 58.767 | 0.000 | −13.758 | 0.795 | 0.000 | 0.607 |
| | surface | | | | | | |

| | | | | | | |
|---|---|---|---|---|---|---|
| Surface to be scanned | 56.245 | 0.000 | −112.686 | −0.021 | 0.000 | −1.000 |

Optical arrangements

| | | Incident optical system LC, imaging optical system SC | | | | | |
|---|---|---|---|---|---|---|---|
| | | | | | Direction of optical axis | | |
| | | Coordinates of surfaces | | | (indicated as direction cosine) | | |
| | | X- | Y- | Z- | X | Y | Z |
| | | coordinate | coordinate | coordinate | component | component | component |
| Light source | | −45.642 | 157.991 | 7.617 | −0.208 | 0.977 | 0.047 |
| Anamorphic | Incident | −38.666 | 125.171 | 6.035 | −0.208 | 0.977 | 0.047 |
| lens | surface | | | | | | |
| | Light | −38.043 | 122.240 | 5.893 | −0.208 | 0.977 | 0.047 |
| | emitting | | | | | | |
| | surface | | | | | | |
| Sub-scanning aperture | | −34.066 | 103.529 | 4.991 | −0.208 | 0.978 | 0.000 |
| Main-scanning aperture | | −28.693 | 78.253 | 3.773 | −0.208 | 0.978 | 0.000 |
| Polygon | Deflection | 0.000 | 0.000 | 0.000 | — | — | — |
| mirror | surface | | | | | | |
| Imaging | Incident | −38.060 | 0.000 | 0.000 | −1.000 | 0.000 | 0.000 |
| lens 6 | surface | | | | | | |
| | Light | −46.260 | 0.000 | 0.000 | −1.000 | 0.000 | 0.000 |
| | emitting | | | | | | |
| | surface | | | | | | |
| Mirror M2 | Reflective | −93.881 | 0.000 | −4.681 | −0.997 | 0.000 | 0.081 |
| | surface | | | | | | |
| Imaging | Incident | −54.929 | 0.000 | −15.462 | −0.987 | 0.000 | 0.161 |
| lens 7 | surface | | | | | | |
| | Light | −54.929 | 0.000 | −15.462 | −0.987 | 0.000 | 0.161 |
| | emitting | | | | | | |
| | surface | | | | | | |
| Mirro M3 | Reflective | −50.685 | 0.000 | −16.153 | −0.987 | 0.000 | 0.161 |
| | surface | | | | | | |

| | | | | | | |
|---|---|---|---|---|---|---|
| Surface to be scanned | −26.755 | 0.000 | −112.686 | −0.021 | 0.000 | −1.000 |

TABLE 8
Aspheric surface coefficients

| | | Anamorphic lens | | Imaging lens 6 | | Imaging lens 7 | |
|---|---|---|---|---|---|---|---|
| | | | Light | | Light | | Light |
| | | Incident | emitting | Incident | emitting | Incident | emitting |
| | | surface | surface | surface | surface | surface | surface |
| Generatrix | R | ∞ | 3.7169E+01 | −7.1974E+01 | −4.4323E+01 | −4.0000E+03 | 3.8392E+02 |
| | K | — | — | 8.9207E−01 | −1.1617E+00 | 0.0000E+00 | −7.6261E+01 |
| | B1 | — | — | 0.0000E+00 | 0.0000E+00 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | 0.0000E+00 | 0.0000E+00 | 0.0000E+00 |
| | B4 | — | — | −7.6122E−07 | −1.5192E−06 | 0.0000E+00 | −1.3441E−07 |
| | B5 | — | — | 0.0000E+00 | 0.0000E+00 | 0.0000E+00 | 0.0000E+00 |
| | B6 | — | — | 6.7890E−09 | 1.7497E−09 | 0.0000E+00 | 7.4548E−12 |
| | B7 | — | — | 0.0000E+00 | 0.0000E+00 | 0.0000E+00 | 0.0000E+00 |
| | B8 | — | — | −5.8886E−12 | 9.6400E−13 | 0.0000E+00 | −3.3045E−16 |
| | B9 | — | — | 0.0000E+00 | 0.0000E+00 | 0.0000E+00 | 0.0000E+00 |
| | B10 | — | — | 1.6170E−15 | −1.1955E−15 | 0.0000E+00 | 7.0161E−21 |
| Meridian R | r | ∞ | 2.6170E+01 | 2.0000E+01 | 5.4586E+01 | 4.6180E+01 | −1.1039E+02 |
| | E1 | — | — | 0.0000E+00 | 0.0000E+00 | 0.0000E+00 | −7.5338E−07 |
| | E2 | — | — | 0.0000E+00 | 3.9703E−06 | 5.2667E−09 | 1.7876E−06 |
| | E3 | — | — | 0.0000E+00 | 0.0000E+00 | 0.0000E+00 | −7.4764E−10 |
| | E4 | — | — | 0.0000E+00 | 9.8636E−08 | 0.0000E+00 | −2.8119E−10 |
| | E5 | — | — | 0.0000E+00 | 0.0000E+00 | 0.0000E+00 | 1.8249E−13 |
| | E6 | — | — | 0.0000E+00 | −2.8867E−10 | 0.0000E+00 | 4.0715E−14 |
| | E7 | — | — | 0.0000E+00 | 0.0000E+00 | 0.0000E+00 | −1.7396E−17 |
| | E8 | — | — | 0.0000E+00 | 3.6216E−13 | 0.0000E+00 | −3.2492E−18 |
| | E9 | — | — | 0.0000E+00 | 0.0000E+00 | 0.0000E+00 | 5.0877E−22 |
| | E10 | — | — | 0.0000E+00 | −1.6189E−16 | 0.0000E+00 | 9.9771E−23 |
| Noncircular | M (0, 1) | — | — | 0.0000E+00 | 1.1363E−01 | −1.4991E−01 | 7.9534E−02 |
| meridian | M (1, 1) | — | — | 0.0000E+00 | 0.0000E+00 | −2.0408E−05 | −1.3182E−05 |
| | M (2, 1) | — | — | 0.0000E+00 | −5.0715E−05 | −3.5067E−08 | −1.5471E−05 |
| | M (3, 1) | — | — | 0.0000E+00 | 0.0000E+00 | 4.8371E−08 | 4.4620E−08 |
| | M (4, 1) | — | — | 0.0000E+00 | 0.0000E+00 | −5.2294E−10 | 1.8119E−09 |
| | M (5, 1) | — | — | 0.0000E+00 | 0.0000E+00 | −1.0184E−11 | −8.8072E−12 |
| | M (6, 1) | — | — | 0.0000E+00 | 0.0000E+00 | 2.0726E−13 | −1.6626E−13 |
| | M (7, 1) | — | — | 0.0000E+00 | 0.0000E+00 | 9.4474E−16 | 7.7608E−16 |
| | M (8, 1) | — | — | 0.0000E+00 | 0.0000E+00 | −2.8675E−18 | 2.4261E−17 |
| | M (9, 1) | — | — | 0.0000E+00 | 0.0000E+00 | −2.8613E−20 | −2.1130E−20 |
| | M (10, 1) | — | — | 0.0000E+00 | 0.0000E+00 | 7.5994E−23 | −4.7977E−22 |
| Diffractive | C (2, 2) | −7.8466E−03 | — | — | — | — | — |
| surface | C (0, 2) | −8.6690E−03 | — | — | — | — | — |

The effect of the optical scanning apparatus 200 according to the present exemplary embodiment will now be described.

Among the imaging optical systems SA, SB, SC, and SD in the present exemplary embodiment, the imaging optical systems SA and SB have similar configurations and optical actions to those of the imaging optical systems SD and SC, respectively. Thus, the effect of the imaging optical systems SA and SB will be described.

In the optical scanning apparatus 200 according to the present exemplary embodiment, as shown in Tables 6 and 8, the light emitting surfaces of the lenses 6A and 6B are meridional tilt surfaces with aspherical coefficients m_{i, j}≠0.

Compared with a conventional lens that does not use a meridional tilt surface, the angles of the light beams RA and RB according to the present exemplary embodiment respectively passed through the lenses 6A and 6B in the sub-scanning cross section from the reference surface can be increased. This allows the mirror M2 to be arranged near the lenses 6A and 6B while avoiding interference with the light beam RA. This downsizes the optical scanning apparatus 200.

The lenses 6A and 6B according to the present exemplary embodiment are multistage lenses that are arranged in the sub scanning direction, each of which the incident surface and the light emitting surface are formed integrally. This allows the plural light beams RA, RB to share the lens, reducing the number of lenses used, achieving small size and low cost of the optical scanning apparatus 200.

In the multistage lenses according to the present exemplary embodiment, at least one of the incident surfaces and the light emitting surfaces of the lenses 6A and 6B has a lens surface shape asymmetric with respect to the reference surface P0 in the sub scanning direction, and the upper shape and the lower shape thereof with respect to the reference surface P0 differ from each other.

As shown in Tables. 6 and 8, the aspherical coefficients m1_{0, 1} and m3_{0, 1}, which are the amounts of meridional tilt on the axis (y=0) of the light emitting surfaces of the lenses 6A and 6B according to the present exemplary embodiment, are −3.9283E-02 and 1.1363E-01, respectively, and satisfy the inequalities (1), (1a), and (1b). As a result, the optical scanning apparatus 200 is downsized for the same reason as that described in the first exemplary embodiment.

As shown in Tables 5 and 7, the optical distances L1 and L2 on the optical axis from the deflection point C0 to the lenses 7A and 7B according to the present exemplary embodiment are 100.8 mm and 122 mm, respectively, and satisfy the inequalities (2), (3), (3a), and (3b). As a result, the optical scanning apparatus 200 is downsized for the same reason as that described in the first exemplary embodiment.

As described above, in the optical scanning apparatus 200 according to the present exemplary embodiment, the lenses and the mirrors arranged to satisfy the above-described relationships can downsize the optical scanning apparatus 200 while avoiding increase in the distance between the photosensitive members of the image formation apparatus provided with the optical scanning apparatus 200.

The exemplary embodiments have been described. The present invention is not limited to these exemplary embodiments, and various modifications and changes can be made within the scope of the gist of the present invention. The scope of the following claims is to be accorded the broadest interpretation so as to encompass all such modifications and equivalent structures and functions.

### [Image Formation Apparatus]

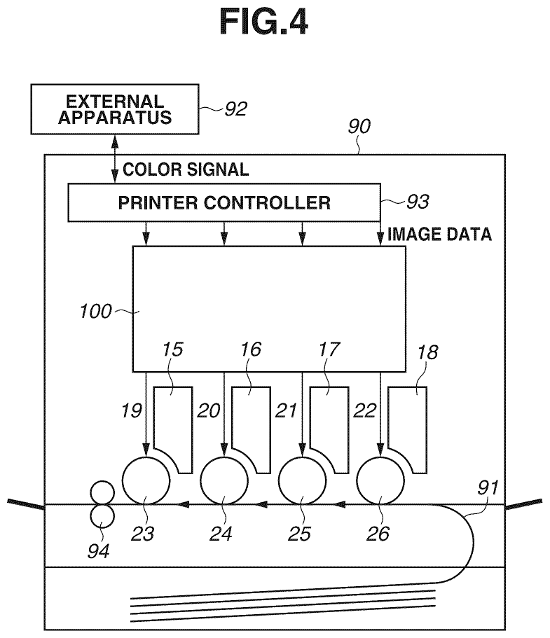

FIG. 4 is a sub-scanning cross-sectional view of main components of a color image formation apparatus 90 in which the optical scanning apparatus 100 according to the first exemplary embodiment or the optical scanning apparatus 200 according to the second exemplary embodiment is included.

The image formation apparatus 90 is a tandem color image formation apparatus that records image information on the surfaces of the photosensitive drums as image carriers using the optical scanning apparatus 100 according to the first exemplary embodiment or the optical scanning apparatus 200 according to the second exemplary embodiment.

The image formation apparatus 90 includes the optical scanning apparatus 100 according to the first exemplary embodiment or the optical scanning apparatus 200 according to the second exemplary embodiment, photosensitive drums (photosensitive bodies) 23, 24, 25, and 26 as the image carriers, and developing devices 15, 16, 17, and 18. The image formation apparatus 90 also includes a conveyor belt 91, a controller (a controller) 93, and a fixing device 94.

The image formation apparatus 90 receives signals (code data) of colors red (R), green (G), and blue (B) that are output from an external device 92, such as a personal computer.

The controller 93 in the image formation apparatus 90 converts the input color signals into image data (dot data) about cyan (C), magenta (M), yellow (Y), and black (K).

The converted image data is input to the optical scanning apparatus 100 or 200. Then, the optical scanning apparatus 100 or 200 emits light beams 19, 20, 21, and 22, each of which is modulated according to the respective pieces of image data, and photosensitive surfaces of the photosensitive drums 23, 24, 25, and 26 are exposed to these light beams, respectively.

Charging rollers (not illustrated) that each uniformly charge the surfaces of the corresponding photosensitive drum of the photosensitive drums 23, 24, 25, and 26 are provided in constant with the surfaces. Then, the surfaces of the photosensitive drums 23, 24, 25, and 26 charged by the charging rollers are irradiated with the light beams 19, 20, 21, and 22, respectively, by the optical scanning apparatus 100 or 200.

As described above, the light beams 19, 20, 21, and 22 modulated based on the image date about the colors, respectively, form electrostatic latent images on the surfaces of the photosensitive drums 23, 24, 25, and 26. The formed electrostatic latent images are developed as toner images by the developing devices 15, 16, 17, and 18 disposed in contact with the photosensitive drums 23, 24, 25, and 26, respectively.

The toner images developed by the developing devices 15 to 18 are transferred in an overlapping manner to a not-illustrated sheet (a transfer material) to form one full-color image. The sheet is conveyed on the conveyor belt 91 by a not-illustrated transfer roller (a transfer unit) disposed to face the photosensitive drums 23 to 26.

The sheet with the unfixed toner image transferred, as described above, is further conveyed to the fixing device 94 behind (on the left in FIG. 4) the photosensitive drums 23, 24, 25, and 26. The fixing device 94 includes a fixing roller including a not-illustrated fixing heater therein and a pressure roller disposed in pressure contact with the fixing roller. The sheet conveyed from the transfer unit is heated while being pressed in the pressure contact section between the fixing roller and the pressure roller. In this way, the unfixed toner image on the sheet is fixed. Further, a not-illustrated sheet discharge roller is disposed behind the fixing roller, and the sheet discharge roller discharges the sheet with the fixed image thereon to the outside of the image formation apparatus 90.

The color image formation apparatus 90 records image signals (image information) on the photosensitive surfaces of the photosensitive drums 23, 24, 25, and 26 in a manner to correspond to the respective colors of C, M, Y, and K using the optical scanning apparatus 100 or 200, to print the color image at high speed.

As the external device 92, for example, a color image reading device that includes a CCD sensor can be used. In this case, a color digital copier includes this color image reading device and the color image formation apparatus 90.

This application claims the benefit of priority from Japanese Patent Applications No. 2023-215786, filed Dec. 21, 2023, and No. 2024-186517, filed Oct. 23, 2024, which are hereby incorporated by reference herein in their entirety.

What is claimed is:

1. An optical scanning apparatus comprising:
a deflector including a deflection surface, on which a first light beam and a second light beam are deflected to scan a first scanned surface and a second scanned surface, respectively, in a main scanning direction;
a first optical system configured to guide the first light beam deflected by the deflection surface to the first scanned surface; and
a second optical system configured to guide the second light beam deflected by the deflection surface to the second scanned surface,
wherein the first optical system includes a first refractive element, a second refractive element, and a first reflective element arranged in an order from the deflection surface to the first scanned surface,
wherein the second optical system includes a third refractive element, a second reflective element, a fourth refractive element, and a third reflective element arranged in an order from the deflection surface to the second scanned surface,
wherein at least one of the first refractive element and the third refractive element includes an optical surface in which a normal line on an optical axis is non-parallel to the optical axis in a sub-scanning cross section, and
wherein distances on the optical axis from an axial deflection point on the deflection surface to the second refractive element and the fourth refractive element differ from each other.

2. The optical scanning apparatus according to claim 1, wherein the first refractive element and the third refractive element are formed integrally with each other.

3. The optical scanning apparatus according to claim 1, wherein incident surfaces of the first refractive element and the third refractive element have the same shape in effective regions.

4. The optical scanning apparatus according to claim 1, wherein a tilt of the normal line in the sub-scanning cross section with respect to the optical axis changes in the main scanning direction.

5. The optical scanning apparatus according to claim 1, wherein the distance on the optical axis from the axial deflection point to the second refractive element is shorter than the distance on the optical axis from the axial deflection point to the fourth refractive element.

6. The optical scanning apparatus according to claim 5, wherein the following inequality is satisfied:
$$0.5 < L 1 / L 2 < 1.$$
where L1 represents the distance on the optical axis from the axial deflection point to the second refractive element, and L2 represents the distance on the optical axis from the axial deflection point to the fourth refractive element.

7. The optical scanning apparatus according to claim 1, wherein light emitting surfaces of the first refractive element and third refractive element are each the optical surface.

8. The optical scanning apparatus according to claim 1, wherein in regard to light emitting surfaces of the first refractive element and the third refractive element, when an origin represents an intersection point with the optical axis, an x-axis is an axis parallel to the optical axis, a y-axis is an axis perpendicular to the optical axis in a main-scanning cross section, a z-axis is an axis perpendicular to the optical axis in a sub-scanning cross section, m_{i, j} represents an aspherical coefficient, r represents a curvature radius in the sub-scanning cross section including the optical axis, Ei represents a change coefficient, and S represents a shape of each of the light emitting surfaces of the first refractive element and the third refractive element in the sub-scanning cross section, in the following equations:
$$S = \frac{{z}^{2} / {r}^{′}}{1 + \sqrt{1 - {( z / {r}^{′} )}^{2}}} + {\sum }_{i , j} {m}_{i , j} {y}^{i} {z}^{j} \qquad [ Equation 1 ]$$
$$\frac{1}{{r}^{′}} = \frac{1}{r} + {\sum }_{i} {E}_{i} {y}^{i} \qquad [ Equation 2 ]$$
a value of m_{0, 1} of the light emitting surface of the first refractive element is smaller than a value of m_{0, 1} of the light emitting surface of the third refractive element.

9. The optical scanning apparatus according to claim 8, wherein the following inequality is satisfied:
$$0.01 < \vert m {1}_{0 , 1} / m {3}_{0 , 1} \vert < 100.$$
where m1_{0, 1} represents the value of m_{0, 1} of the light emitting surface of the first refractive element, and m3_{0, 1} represents the value of m_{0, 1} of the light emitting surface of the third refractive element.

10. The optical scanning apparatus according to claim 8, wherein a sign of m_{0, 1} of the light emitting surface of the first refractive element and a sign of m_{0, 1} of the light emitting surface of the third refractive element differ from each other.

11. An image formation apparatus comprising:
the optical scanning apparatus according to claim 1; and
a developing device configured to develop, as a toner image, an electrostatic latent image formed on a scanned surface by the optical scanning apparatus.

12. An image formation apparatus comprising:
the optical scanning apparatus according to claim 1; and
a controller configured to convert code data output from an external device into an image signal and inputs the image signal to the optical scanning apparatus.
